(19) United States
(12) Patent Application Publication
(10) Pub. No.: US 2025/0346190 A1
(43) Pub. Date: Nov. 13, 2025

(54) Vehicular Trunk Reception Structure

(71) Applicants: HYUNDAI MOTOR COMPANY, Seoul (KR); KIA CORPORATION, Seoul (KR); KOMOS.CO.,LTD, Hwaseong-si (KR)

(72) Inventors: Hoon Chang, Hwaseong-si (KR); Jong Wan Kim, Hwaseong-si (KR); Nam Cheol Kim, Hwaseong-si (KR); Han Mo Kang, Hwaseong-si (KR); Won Woo Chi, Yongin-si (KR); Jong Sun Jang, Hanam-si (KR)

(73) Assignees: HYUNDAI MOTOR COMPANY, Seoul (KR); KIA CORPORATION, Seoul (KR); KOMOS.CO.,LTD, Hwaseong-si (KR)

(21) Appl. No.: 18/954,339

(22) Filed: Nov. 20, 2024

(30) Foreign Application Priority Data
May 9, 2024 (KR) 10-2024-0061112

(51) Int. Cl. B60R 5/02; B60R 11/00; B62D 25/08

(52) U.S. Cl. CPC B60R 5/02; B62D 25/087; B60R 2011/0084

(57) ABSTRACT

A vehicular trunk reception structure includes a body have formed therein an interior space configured to receive and store an article, a board defining a bottom of the body, and a lifting device coupled to the board and lifted from the board in a drawing direction, the lifting device comprising a support, wherein the lifting device comprises at least one plate which is foldable and changeable in height.

### CROSS-REFERENCE TO RELATED APPLICATION

This application claims under 35 U.S.C. § 119(a) the benefit of priority to Korean Patent Application No. 10-2024-0061112 filed on May 9, 2024, the entire contents of which are incorporated herein by reference.

### TECHNICAL FIELD

The present disclosure relates to a vehicular trunk reception structure. More particularly, it relates to a vehicular trunk reception structure which is capable of separately receiving tools and articles according to the size thereof and which has a reception space capable of being divided into subspaces depending on user needs, thereby allowing a narrow space in the trunk of a vehicle to be efficiently used.

### BACKGROUND

Generally, a trunk provided at the rear side of a vehicle is a space configured to accommodate various articles and baggage. The trunk is constructed to accommodate articles of various applications depending on the kind of vehicle such as a sedan and a Sport Utility Vehicle (SUV).

Specifically, a trunk reception cabinet provided in the trunk of a vehicle is configured to receive and store various articles such as various tools, vehicular articles, automotive supplies, emergency supplies and cleaning supplies and further to store various different articles to be used in case of emergency.

In recent years, with the establishment of leisure culture, articles loaded into a vehicle are diversified and are put to practical use. Particularly, with the establishment of leisure culture, articles loaded into a vehicle are diversified and are increased in number, and the number of consumers who buy leisure vehicles having a large accommodation space is also increasing. How to construct an accommodation space of a vehicle efficiently depending on application of the vehicle and on needs in use serves as a factor that exerts significant influence on a user's selection. According to the size of an accommodation space, efficient and stable loading of articles must be considered. Furthermore, it is necessary to facilitate operations of loading and unloading relatively heavy articles.

Recently, as electric vehicles are universalized, the number of vehicles which are constructed such that a trunk is provided not only at the rear side of a passenger compartment but also at the front side of the passenger compartment may increase. Such a trunk may be referred to as a front trunk (or a frunk). In this case, a battery configured to drive the electrical vehicle is disposed below a passenger compartment, and a motor which has a very small volume compared to an engine is also disposed below the passenger compartment, thereby allowing both the front trunk and the rear trunk to be used as accommodation spaces.

The front trunk may be classified into an openable front trunk which is openable at the front surface and a non-openable front trunk which is not openable at the front surface.

Although the openable front trunk, which is constructed such that the front surface thereof is openable, has an enlarged accommodation space, the articles received in the accommodation space may move and thus generate noise because the front surface is openable, thereby causing a problem in that a user must buy an additional reception box or basket.

In addition, the non-openable front trunk is a trunk constructed such that all the surfaces of the trunk are not openable except the upper surface. Accordingly, because all the surfaces of the trunk are closed except the upper surface, articles are easily received in the trunk but there is a problem in that it is inconvenient for a user to load or unload baggage (particularly, a bulky of heavy baggage) because the front surface is closed.

The above information disclosed in this background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art. An object of the present disclosure is to provide a vehicular trunk reception structure which is convertible so as to allow convenient use at the time of loading or unloading baggage.

Another object of the present disclosure is to provide a vehicular trunk reception structure which is constructed such that a minimum surface thereof is simply opened so as to allow a user to easily use the articles positioned in the interior space of the reception structure and to protect user privacy.

Still another object of the present disclosure is to provide a vehicular trunk reception structure capable of being used as a chair or a table for tea drinking which is used in leisure activities, such as a picnic, by virtue of the specific structure of the present disclosure.

The objects of the present disclosure are not limited to the above-mentioned objects, and other objects of the present disclosure, which are not mentioned above, will be clearly understood from the following descriptions of preferred embodiments and will be apparent from the preferred embodiments of the present disclosure. The above objects and other objects of the present disclosure are achieved by the means and combinations thereof disclosed in the claims.

In order to achieve the objects of the present disclosure, the vehicular trunk reception structure according to the present disclosure has the following constructions.

In one aspect, the present disclosure provides a vehicular trunk reception structure including a body having formed therein an interior space configured to receive and store an article, a board defining a bottom of the body, and a lifting device coupled to the board and lifted from the board in a drawing direction, the lifting device comprising a support, wherein the lifting device comprises at least one plate which is foldable and changeable in height.

In a preferred embodiment, the lower surface of the plate may be coupled to one end of the support.

In another preferred embodiment, the support of the lifting device may include links which are positioned opposite each other and each of which is formed into an X shape so as to raise and lower the plate, a guide groove formed in a lower surface of the plate, an angle adjuster configured to allow one end of at least one of the links to be moved along the guide groove, a holding bar connected between the links positioned opposite each other, and a stopper positioned on the lower surface of the plate so as to hold the holding bar.

In still another preferred embodiment, the plate may include a first plate positioned adjacent to the board, a second plate coupled to the first plate via a first hinge, and a third plate coupled to the second plate via a second hinge.

In yet another preferred embodiment, the vehicular trunk reception structure may further include a slide member which is coupled to the board and to which the support is fixed, the slide member having formed therein a continuous groove to allow the links of the support to be moved therealong.

In still yet another preferred embodiment, the board may include a step portion projecting upwards.

In another aspect, the present disclosure provides a vehicular trunk reception structure including a body having formed therein an interior space configured to receive and store an article, a board defining a bottom of the body, and an extension unit configured to open one surface of the body, wherein the extension unit comprises one or more extending members, which are connected to each other and are expanded by means of a folding unit.

In a preferred embodiment, the extension unit may include a first extending member coupled to the board, a second extending member positioned horizontally in conjunction with the first extending member, and a third extending member positioned between the first extending member and the second extending member.

In still another preferred embodiment, the extension unit may further include a fourth extending member including protrusions which are inserted into two or more holes formed in two lateral ends of the third extending member, the fourth extending member being coupled to the third extending member so as to increase a surface area of the extension unit.

In yet another preferred embodiment, the vehicular trunk reception structure may further include a coupler configured to couple the extension unit to the board, and a folding unit configured to allow the one or more extending members to be folded and unfolded.

In still yet another preferred embodiment, the folding unit may include brackets respectively coupled to the first extending member, the second extending member, and the third extending member, a guide pin extending through the brackets to couple the first extending member, the second extending member, and the third extending member to one another, a spring positioned around an outer circumferential surface of the guide pin, and a bushing configured to hold the guide pin and the brackets.

### BRIEF DESCRIPTION OF THE DRAWINGS

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 is a view illustrating a vehicular trunk reception structure according to an embodiment of the present disclosure overall;

FIGS. 2A, 2B, and 2C are views illustrating the sequence in which the vehicular trunk reception structure according to an embodiment of the present disclosure is operated;

FIG. 3 is a view illustrating a coupling structure of the vehicular trunk reception structure;

FIGS. 3A and 3B are enlarged views specifically illustrating the coupling structure of the vehicular trunk reception structure, shown in FIG. 3, according to an embodiment of the present disclosure;

FIG. 4 is a view illustrating a lifting device of the vehicular trunk reception structure according to an embodiment of the present disclosure when viewed from below;

FIG. 5 is a view illustrating an extension unit of the vehicular trunk reception structure according to another embodiment of the present disclosure;

FIGS. 5A, 5B, 5C, and 5D are enlarged views specifically illustrating the extension unit of the vehicular trunk reception structure, shown in FIG. 5, according to another embodiment of the present disclosure; and

FIGS. 6A and 6B are views illustrating the coupling structure between a third extending member and a fourth extending member of the vehicular trunk reception structure according to another embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, the reference numbers refer to the same or equivalent parts of the present disclosure throughout the several figures of the drawing.

### DETAILED DESCRIPTION

Hereinafter, embodiments of the present disclosure will be described in detail with reference to the accompanying drawings. The embodiments of the present disclosure may be modified into various forms, and the scope of the present disclosure should not be construed as being limited to the following embodiments. These embodiments are provided so that this disclosure will be thorough and complete, and will fully convey the scope of the disclosure to those skilled in the art.

The term “part”, “unit” or “module” means a unit for performing at least one function or action, and may be realized by hardware or a combination of hardware.

The terminology used herein is for the purpose of describing particular embodiments only and is not intended to be limiting. As used herein, the singular forms “a,” “an” and “the” are intended to include the plural forms as well, unless the context clearly indicates otherwise.

It will be understood that, although the terms “first” “second,” etc. may be used herein to describe various similar elements, these elements should not be construed to be limited by these terms. These terms are only used to distinguish one element from another.

Hereinafter, embodiments of the present disclosure will be described with reference to the accompanying drawings. In the description of the embodiments with reference to the accompanying drawings, the same or similar elements are assigned the same reference numerals irrespective of their reference numerals, and a redundant description thereof is omitted.

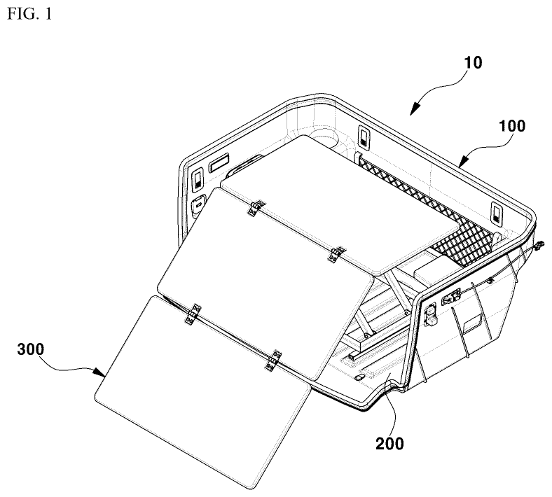

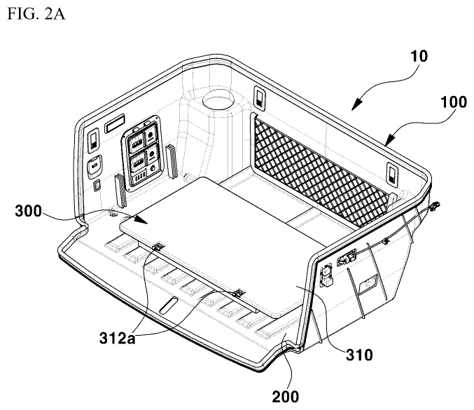

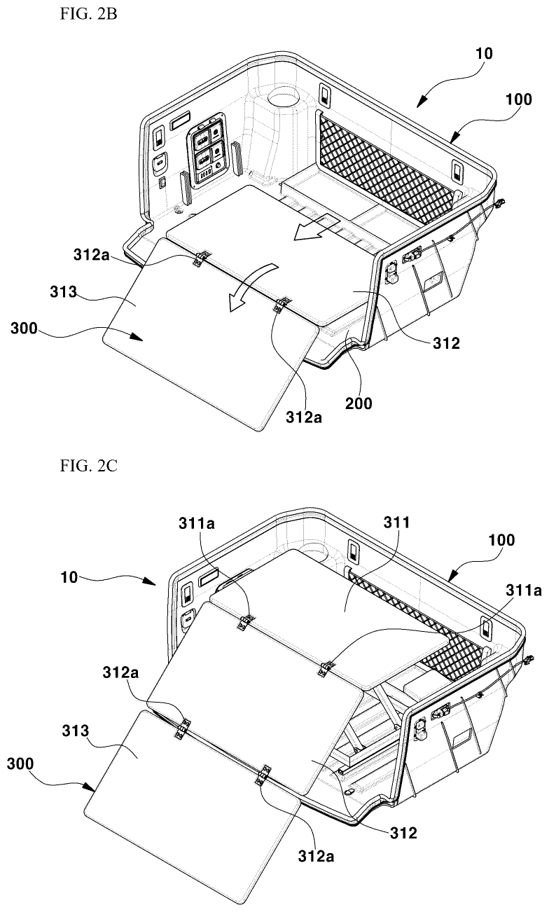

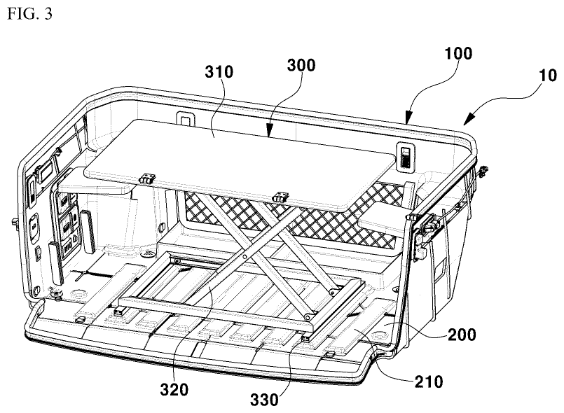

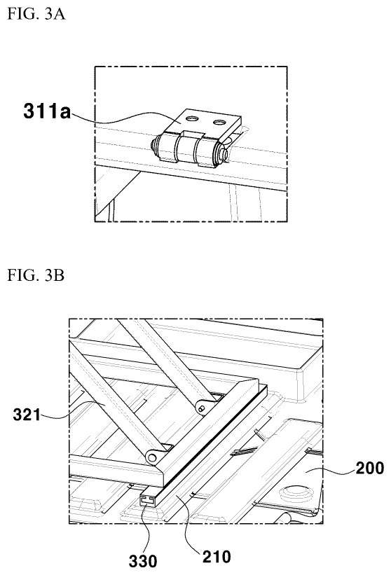

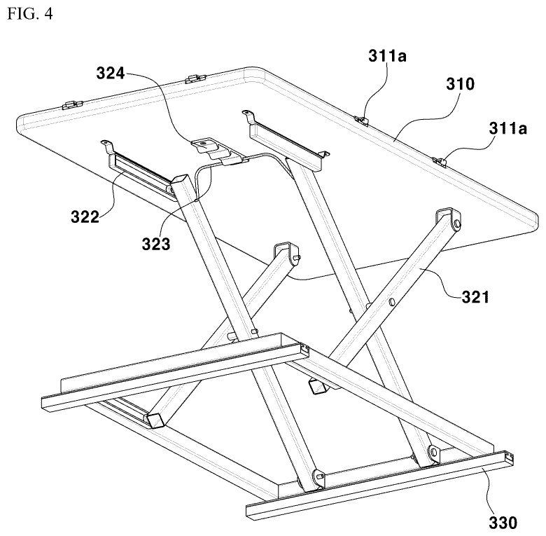

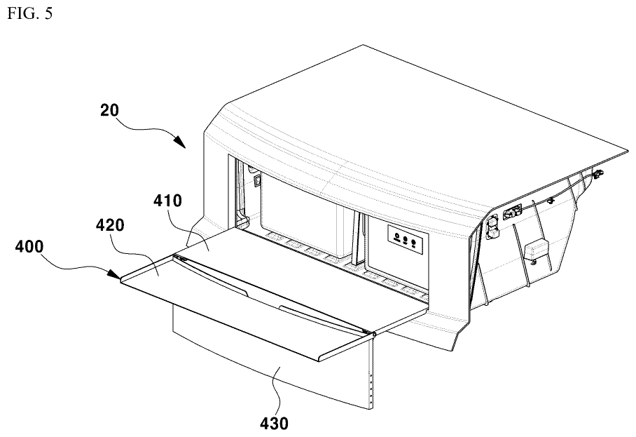

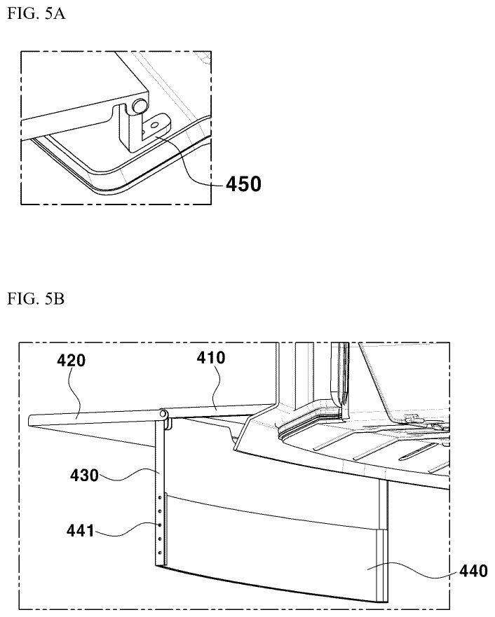

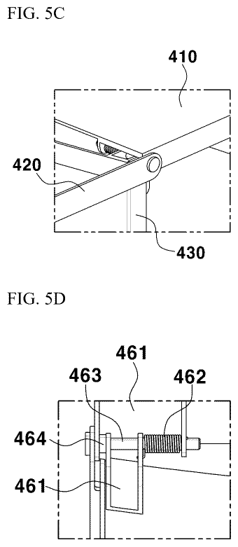

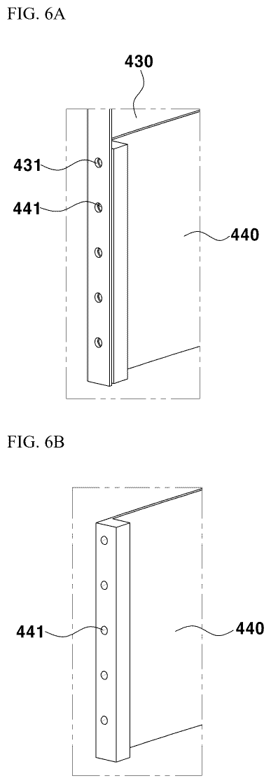

FIG. 1 is a view illustrating a vehicular trunk reception structure according to an embodiment of the present disclosure overall. FIGS. 2A, 2B, and 2C are views illustrating the sequence in which the vehicular trunk reception structure according to an embodiment of the present disclosure is operated. FIG. 3 is a view illustrating a coupling structure of the vehicular trunk reception structure, and FIGS. 3A and 3B are enlarged views specifically illustrating the coupling structure of the vehicular trunk reception structure, shown in FIG. 3, according to an embodiment of the present disclosure. FIG. 4 is a view illustrating a lifting device of the vehicular trunk reception structure according to an embodiment of the present disclosure when viewed from below. FIG. 5 is a view illustrating the extension unit of the vehicular trunk reception structure according to another embodiment of the present disclosure. FIGS. 5A, 5B, 5C, and 5D are enlarged views specifically illustrating the extension unit of the vehicular trunk reception structure, shown in FIG. 5, according to another embodiment of the present disclosure. FIGS. 6A and 6B are views illustrating the coupling structure between a third extending member and a fourth extending member of the vehicular trunk reception structure according to another embodiment of the present disclosure.

First, as illustrated in FIG. 1, the vehicular trunk reception structure 10 according to an embodiment of the present disclosure includes a body 100 having formed therein an interior space configured to receive and store articles, a board 200 defining the bottom of the body 100, and a lifting device 300 fastened to the board 200 and configured to be raised and lowered in a drawing direction with respect to the board 200.

Specifically, the body 100 of the vehicular trunk reception structure 10 has the interior space configured to receive articles and to allow the articles to be retrieved therefrom. Because the body 100 according to the embodiment of the present disclosure is positioned at the front side of a vehicle, the body 100 may be formed to have the same shape as the shape of the front portion of the vehicle. Generally, the body 100 according the embodiment of the present disclosure may be formed to have a shape different from the shape of the trunk positioned at the rear side of the vehicle. The body 100 according to the embodiment of the present disclosure may be defined by at least one partition wall, and the at least one partition wall may be opened so as to allow the articles received therein to be retrieved.

The board 200 of the vehicular trunk reception structure 10 according to the embodiment of the present disclosure may include at least one step portion 210 which is positioned on the bottom of the body 100 in an inward direction. The step portion 210 of the board 200 according to the embodiment of the present disclosure may be provided so as to block movement of the articles received in the interior space during travel of the vehicle. Specifically, the board 200 comes into contact with the articles in the surface area of the step portion 210, thereby preventing movement of the articles received in the interior space.

The lifting device 300 of the vehicular trunk reception structure 10 according to the embodiment of the present disclosure may be coupled to the board 200, and may be lifted in the direction of the bonnet (e.g., hood).

Referring to FIGS. 2A, 2B, and 2C, the lifting device 300 of the vehicular trunk reception structure 10 according to the embodiment of the present disclosure may include at least one plate 310 which includes a first plate 311, a second plate 312, and a third plate 313, which are stacked on one another and are folded and unfolded by means of hinges.

First, the first plate 311 of the plate 310 according to the embodiment of the present disclosure may be positioned closest to the board 200, and may be coupled to the links 321. The first plate 311 may include first hinges 311a. The first plate 311, which is formed into the shape of a large plate, may allow the goods stored in the interior space in the body 100 to be easily slid outwards and thus withdrawn therefrom. In order to slide the articles, one surface of the first plate 311 may be formed into a flat shape without a curved portion or irregularity.

The first hinge 311a of the first plate 311 may connect the second plate 312 to the first plate 311 in a hinge manner such that the second plate 312 is folded onto the first plate 311.

The second plate 312 of the plate 310 according to the embodiment of the present disclosure may be connected to the first hinges 311a, and may be formed into the same shape as the first plate 311. The second plate 312 may be formed so as to allow the articles stored in the interior space to be slid outwards, and one surface of the second plate 312 may be formed into a flat shape like the first plate 311. The first hinges 311a and second hinges 312a may be coupled to the second plate 312. The first plate 311 and the second plate 312 may be stacked on the board 200, and may be unfolded outwards. The second plate 312 may be rotated outwards about the first hinges 311a.

FIG. 3 is a view illustrating a coupling structure of the vehicular trunk reception structure, and FIGS. 3A and 3B are enlarged views specifically illustrating the coupling structure of the vehicular trunk reception structure, shown in FIG. 3, according to an embodiment of the present disclosure. FIG. 4 is a view illustrating a lifting device of the vehicular trunk reception structure according to an embodiment of the present disclosure when viewed from below.

Referring to FIGS. 3, 3A, 3B, and 4, the third plate 313 of the plate 310 according to the embodiment of the present disclosure may be provided with second hinges 312a in order to be connected to the second plate 312. The third plate 313 may be formed to have the same shape as the first plate 311 and the second plate 312, like the first plate 311 and the second plate 312, and may be formed to have a flat shape so as to allow the articles stored in the interior space to be easily slid outwards. The third plate 313 is the plate that is positioned at the highest level among the first plate 311, the second plate 312 and the third plate 313. The third plate 313 may be positioned close to the bonnet, and may be positioned at the distal end of the trunk reception structure when the plate 310 is unfolded.

However, the third plate 313 is not limited to the plate that is positioned at the highest level, and the second plate 312 may be positioned at the highest level and be adjacent to the bonnet depending on the manner in which a user folds the plate 310. By virtue of the first hinges 311a and the second hinges 312a, any of the second plate 312 and the third plate 313 may be positioned closest to the bonnet depending on a direction in which a user rotates the plate 310. In this way, the plate 310 may be freely folded and unfolded in any direction in which a user can conveniently fold and unfold the plate 310.

The support 320 of the lifting device 300 according to an embodiment of the present disclosure may be coupled to the bottom surface of the first plate 311 so as to vertically raise the plate 310 toward the bonnet. The support 320 may include the links 321, an angle adjuster 322, a holding bar 323, and a stopper 324.

Specifically, FIGS. 3B and 4, the links 321 of the support 320 of the lifting device 300 according to an embodiment of the present disclosure may be fastened to the board 200 and may be disposed so as to form an X shape. Accordingly, the first plate 311 may be raised or lowered by increasing or decreasing the intersection angle of the X shape. Although this embodiment describes that the first plate 311 is raised, the second plate 312 and the third plate 313 which are coupled to the first plate 311 may also be raised. The links 321 may further include a rectangular frame close to the board 200, and the X-shaped links may be vertically disposed on the rectangular frame.

The links 321 may be coupled to the slide members 330 positioned on the board 200. The links 321 may be coupled to the at least one step portions 210 of the board 200 which are linearly disposed, and may be vertically disposed on the board 200.

As described above, the links 321 may be vertically erected into the X shape, and may be positioned at opposite locations, thereby stably supporting the first plate 311 at opposite sides.

One of the X-shaped links 321, which are positioned opposite each other, may be coupled at one end thereof to the frame positioned close to the board 200 and at the other end to the first plate 311. The holding bar 323 may be disposed between the opposed links 321 so as to connect the opposed links 321 to each other.

The support 320 may further include the angle adjuster 322 coupled to the lower surface of the first plate 311. The other end of each of the X-shaped links 321 may be coupled to the angle adjuster 322, and the other end of the link 321 may be inserted into a guide hole formed in the angle adjuster 322 so as to be moved horizontally. The angle of the link 321 may be adjusted in this way, thereby making it possible to adjust the height of the first plate 311. The stopper 324 may be mounted on the lower surface of the first plate 311. When the holding bar 323 catches in one of the grooves formed in the stopper 324, the links 321 and the first plate 311 may be stably supported.

Next, the slide members 330 of the lifting device 300 according to an embodiment of the present disclosure may be coupled to the step portions 210 of the board 200, and may be disposed parallel to each other so as to stably support the link 321. Specifically, a continuous groove may be longitudinally formed in each of the sliding members 330 of the lifting device 300, and a slide protrusion may be inserted into the continuous groove. The link may be mounted to the board when the slide protrusion is inserted into the continuous groove, and the link may be separated from the board when the slide protrusion is separated from the continuous groove.

Specifically, one surface of the slide member 330 may be coupled to the step portion 210 of the board 200, and the other surface of the slide member 330 that is positioned opposite the one surface may be coupled to the rectangular frame. The frame may be coupled to and separated from the continuous groove in the slide member 330. Accordingly, when the slide members 330 are not used by a user, the slide member 330 may be separated from the board 200.

FIG. 5 is a view illustrating the extension unit of the vehicular trunk reception structure according to another embodiment of the present disclosure. FIGS. 5A, 5B, 5C, and 5D are enlarged views specifically illustrating the extension unit of the vehicular trunk reception structure, shown in FIG. 5, according to another embodiment of the present disclosure. FIGS. 6A and 6B are views illustrating the coupling structure between a third extending member and a fourth extending member of the vehicular trunk reception structure according to another embodiment of the present disclosure.

Referring to FIGS. 5, 5A, 5B, 5C, 5D, 6A, and 6B, the vehicular trunk reception structure 20 according to another embodiment of the present disclosure may include the body 100, the board 200, and the extension unit 400.

The body 100 of the vehicular trunk reception structure 20 according to another embodiment of the present disclosure may have formed therein the interior space configured to receive and store articles therein. Here, the extension unit 400, which will be described later, may be opened such that articles are received in or retrieved from the interior space. Because the body 100 of the vehicular trunk reception structure 20 according to another embodiment of the present disclosure is positioned at the front side of a vehicle, the body 100 may be formed to have the same shape as the shape of the front portion of the vehicle. Generally, the body 100 may be formed to have a shape different from the shape of the trunk positioned at the rear side of the vehicle. The body 100 according to the embodiment of the present disclosure may be defined by at least one partition wall, and one of the at least one partition wall may serve as the extension unit 400.

The board 200 according to the embodiment of the present disclosure may be positioned at the bottom of the body 100, and may include at least one step portion 210 which extends toward the interior space. In a conventional vehicle, there is a problem in that the articles loaded in the interior space in the trunk of the vehicle move because the articles loaded in the interior space are not held during travel of the vehicle. In order to solve this problem, the step portions 210 and non-step portions may be alternately disposed so as to prevent movement of the articles loaded in the interior space.

The extension unit 400 of the vehicular trunk reception structure 20 according to the embodiment of the present disclosure may include one or more extending members 410, 420, 430 and 44 which are connected to one another. The extending members 410, 420, 430 and 440 may be folded and unfolded by means of (e.g., with) a folding unit 460. Accordingly, the extension unit 400 may be received when not in use, and may be embodied by at least one of the walls of the body 100.

Specifically, the extension unit 400 of the vehicular trunk reception structure 20 according to the embodiment of the present disclosure may include the first extending member 410, the second extending member 420, the third extending member 430, the fourth extending member 440, couplers 450, and the folding unit 460.

First, the first extending member 410 of the extension unit 400 may be coupled to the board 200 via the couplers 450 so as to be positioned parallel to the board 200. The couplers 450 may be arranged on the board 200 in the longitudinal direction of the first extending member 410. The couplers 450 may be configured to receive the second extending member 420 and the third extending member 430, which are coupled to the first extending member 410, and to allow the first extending member 410 to be folded in a vertical direction.

The second extending member 420 of the extension unit 400 may be positioned horizontally in conjunction with the first extending member 410. The third extending member 430 may be coupled to the first extending member 410 via the folding unit 460. The second extending member 420 may be formed to have the same shape as the first extending member 410. The second extending member 420 may be received in the body 100 via the couplers 450 coupled to the first extending member 410.

The third extending member 430 of the extension unit 400 may be positioned between the first extending member 410 and the second extending member 420, and may be coupled to the first extending member 410 and the second extending member 420 via the folding unit 460 and extend in a vertical direction. Specifically, as illustrated in FIGS. 5B and 5D, the third extending member 430 may be vertically positioned between the first extending member 410 and the second extending member 420. The third extending member 430 may be provided at two lateral sides thereof with lateral ends which have formed therein holes 431. Accordingly, protrusions 441 of the fourth extending member 440 may be inserted into the holes 431 in the lateral ends such that the fourth extending member 440 extends from the third extending member 430.

When a user desires to extend the third extending member 430 of the extension unit 400, the fourth extending member 440 may further be coupled to the third extending member 430. The fourth extending member 440 may be formed with the same surface area as the surface area of the third extending member 430, and may be provided at lateral sides thereof with the protrusions 441 to be inserted into the holes 431 in the third extending member 430.

As illustrated in FIGS. 6A and 6B, the protrusions 441 of the fourth extending member 440 may be inserted into the holes 431 formed in the two lateral ends of the third extending member 430. Accordingly, the fourth extending member 440 may be coupled to the third extending member 430 depending on user needs.

The first extending member 410, the second extending member 420, and the third extending member 430 may be coupled to one another via the folding unit 460. The folding unit 460 of the extension unit 400 may include brackets 461, a spring 462, a guide pin 463, and a bushing 464. Referring to FIG. 5D, the brackets 461 of the folding unit 460 may be respectively coupled to the first extending member 410, the second extending member 420, and the third extending member 430, and the guide pin 463 may extend through the brackets 461 to couple the first extending member 410, the second extending member 420, and the third extending member 430 to one another. The spring 462 may be positioned around the outer circumferential surface of the guide pin 463 so as to prevent separation of the first extending member 410, the second extending member 420, and the third extending member 430 and to rotate the second extending member 420 relative to the first extending member 410. Furthermore, the guide pin 463 may be provided with the bushing 464 so as to assure stable rotation of the brackets 461 and to hold the guide pin 463 and the brackets 461.

As described above, the vehicular trunk reception structure 10 or 20 according to embodiments of the present disclosure may not only be used to load articles into the trunk but also be used as a rail by coupling the lifting device 300 to the body 100 when large or heavy baggage is unloaded. Furthermore, the vehicular trunk reception structure according to the embodiments of the present disclosure may be embodied as a chair or a table for tea drinking in leisure activities, such as a picnic, by virtue of the extension unit 400.

In addition, because the minimum space of the body 100 is exposed by opening only the extension unit 400 of the body 100, the vehicular trunk reception structure according to the embodiment of the present disclosure is capable of protecting user privacy.

By virtue of the above-described construction of the embodiments of the present disclosure, the present disclosure offers the following effects.

The present disclosure provides a vehicular trunk reception structure which is convertible into a rail so as to allow convenient use at the time of loading or unloading baggage.

In addition, the present disclosure provides a vehicular trunk reception structure in which a minimum surface of the body is opened so as to allow a user to easily use the articles positioned in the interior space in the body and to assure protection of user privacy.

Furthermore, the present disclosure provides a vehicular trunk reception structure capable of being used as a chair or a table for tea drinking which is used in leisure activities, such as a picnic, by virtue of the lifting device according to an embodiment and the extension unit according to another embodiment.

The detailed description is illustrative of the present disclosure. Also, the above description is intended to illustrate and explain preferred embodiments of the present disclosure, and the present disclosure may be implemented in various other combinations, modifications, and environments. In other words, the present disclosure may be changed or modified within the scope of the concept of the disclosure disclosed herein, within the equivalent scope of the disclosure, and/or within the skill and knowledge of the art. The described embodiments illustrate the best state of the art to implement the technical idea of the present disclosure, and various changes may be made thereto as demanded for specific applications and uses of the present disclosure. Accordingly, the detailed description is not intended to limit the present disclosure to the embodiments. Also, the appended claims should be construed as encompassing such other embodiments.

What is claimed is:

1. A vehicular trunk reception structure comprising:
a body having formed therein an interior space configured to receive and store an article;
a board defining a bottom of the body; and
a lifting device coupled to the board and lifted from the board, the lifting device comprising a support,
wherein the lifting device comprises at least one plate which is foldable and changeable in height,
wherein a lower surface of the plate is coupled to one end of the support of the lifting device.

2. The vehicular trunk reception structure of claim 1, wherein the support of the lifting device comprises:
links which are positioned opposite each other and each link is formed into an X shape to raise and lower the plate;
a guide groove formed in a lower surface of the plate;
an angle adjuster configured to allow one end of at least one of the links to be moved along the guide groove;
a holding bar connected between the links positioned opposite each other; and
a stopper positioned on the lower surface of the plate to hold the holding bar.

3. The vehicular trunk reception structure of claim 1, wherein the plate comprises:
a first plate positioned adjacent to the board;
a second plate coupled to the first plate via a first hinge; and
a third plate coupled to the second plate via a second hinge.

4. The vehicular trunk reception structure of claim 2, further comprising a slide member which is coupled to the board and to which the support is fixed, the slide member having formed therein a continuous groove to allow the links to be moved therealong.

5. The vehicular trunk reception structure of claim 1, wherein the board comprises a step portion projecting upwards.

6. A vehicular trunk reception structure comprising:
a body having formed therein an interior space configured to receive and store an article;
a board defining a bottom of the body; and
an extension unit configured to open one surface of the body,
wherein the extension unit comprises one or more extending members, which are connected to each other and are expanded with a folding unit.

7. The vehicular trunk reception structure of claim 6, wherein the extension unit comprises:
a first extending member coupled to the board;
a second extending member positioned horizontally in conjunction with the first extending member; and
a third extending member positioned between the first extending member and the second extending member.

8. The vehicular trunk reception structure of claim 7, wherein the extension unit further comprises a fourth extending member including protrusions which are inserted into two or more holes formed in two lateral ends of the third extending member, the fourth extending member being coupled to the third extending member to increase a surface area of the extension unit.

9. The vehicular trunk reception structure of claim 6, further comprising:
a coupler configured to couple the extension unit to the board; and
the folding unit configured to allow the one or more extending members to be folded and unfolded.

10. The vehicular trunk reception structure of claim 9, wherein the folding unit comprises:
brackets respectively coupled to a first extending member, a second extending member, and a third extending member;
a guide pin extending through the brackets to couple the first extending member, the second extending member, and the third extending member to one another;
a spring positioned around an outer circumferential surface of the guide pin; and
a bushing configured to hold the guide pin and the brackets.
